(19) United States
(12) Patent Application Publication
(10) Pub. No.: US 2003/0152687 A1
(43) Pub. Date: Aug. 14, 2003

(54) Process for the isolation of milk proteins

(76) Inventors: Adrien Beaudoin, Rock Forest (CA); Maryse St-Georges, Montreal (CA); Genevieve Martin, Quebec (CA)

Correspondence Address: Eric Fincham, 316 Knowlton Road, Lac Brome, QC, JOE 1VO, CA

(21) Appl. No.: 10/280,849

(22) Filed: Oct. 25, 2002

Related U.S. Application Data
(63) Continuation-in-part of application No. 09/679,175, filed on Oct. 4, 2000, now abandoned.
Application No. 09/679,175 is a continuation-in-part of application No. 09/302,157, filed on Apr. 29, 1999, now abandoned.

(30) Foreign Application Priority Data
Oct. 8, 1998 (CA) 2,248,380
Nov. 27, 1998 (CA) 2,256,284

(51) Int. Cl. A23C 9/16

(52) U.S. Cl. 426/588

(57) ABSTRACT

A method for the recovery of proteins from a liquid milk product wherein the liquid milk product is mixed with a precipitating agent selected from ethanol and acetone and the mixture agitated for a period of time sufficient to form a precipitate which is subsequently recovered. The proteins recovered include enzymes which are normally destroyed during pasteurization.

The present application is a continuation-in-part of application Ser. No. 09/679,175 filed Oct. 4, 2000 which is a continuation-in-part of application Ser. No. 09/302,157 filed Apr. 29, 1999.

### FIELD OF THE INVENTION

The present invention relates to a method and product, and more particularly, relates to a protein product derived from milk and to methods of treating milk and/or milk byproducts.

### BACKGROUND OF THE INVENTION

Milk is a major source of dietary proteins both in humans and animals. Milk generally consists of globules of butterfat suspended in a solution containing lactose (milk sugar), proteins and salts of calcium, phosphorous, chlorine, sodium, potassium and sulphur.

The various milk proteins may be classified (ADSA's nomenclature) as follows: a) caseins, b) whey proteins consisting mainly of lactalbumin, lactoglobulin, immunoglobulins and serum albumin, c) milk fat globule membrane proteins, and d) enzymes.

Milk is widely used as a beverage and particularly for the feeding of children. In the United States, approximately half the milk produced is consumed as fresh milk, with the balance being utilized in a wide range of products such as cheese, butter, dried milk powder, ice cream, yoghurt, etc. Almost all the milk consumed as fresh milk is subjected to treatment in order to ensure its safety for human use. This treatment usually comprises a pasteurization which overcomes the problem of the presence of virus and bacteria which may be derived either from the animal producing the milk or from its environment, both during and after milk collection. While a high degree of safety is provided by the pasteurization process followed by maintaining the milk at cool temperatures, one of the major drawbacks of the heat treatment is the inactivation and denaturation of the enzymes and other proteins of milk. Among these denatured proteins, one finds immunoglobulins which play a role in the defense of the organism against various types of infectious agents. The heat treatment of pasteurization, in addition to protein denaturation, also affects lipids causing their peroxidation.

A further major drawback of the heat treatment of milk is the loss of digestibility which is associated with denaturation of proteases, lipases, amylases, phosphatases and other enzymes. In order to overcome these disadvantages, it has been proposed in the art to use techniques such as nano-filtration and ultra-filtration. However, these processes are costly and the endogenous digestive enzymes can deteriorate the quality of milk proteins when the product is kept at room temperature for periods of time. The use of high pressure has also been used to destroy bacteria in milk.

It would therefore be advantageous to provide a method to recover milk proteins in their native form or in a state that preserves structural and functional properties of proteins. This would be an asset with the advent of transgenic animals that produce new proteins and polypeptides by recombinant technology.

It would also be highly advantageous to produce a milk protein concentrate which keeps the activity of its enzymes in the concentrate. In other words, the milk protein concentrate ideally will contain all of the proteins and enzymes from a liquid milk product.

### SUMMARY OF THE INVENTION

It is therefore an object of the present invention to provide a method for the treatment of milk to recover proteinaceous material from the milk, and which method can be practiced on a commercial scale.

It is a further object of the present invention to provide a protein product derived from milk and which protein product maintains its enzymatic properties.

It is a further object of the present invention to provide a method for the recovery of proteins from milk and which method also treats the proteins with a bactericide and viricide.

It is a further object of the present invention to provide a method for the recovery of all of the proteins and enzymes from a liquid milk product.

According to the present invention, there is provided a method for the recovery of all of the main proteins and enzymes from a liquid milk product, the method comprising the steps of supplying a raw unpasteurized liquid milk product, adding a precipitating agent selected from the group consisting of ethanol and acetone to the raw unpasteurized liquid milk product, mixing the raw unpasteurized milk product and the precipitating agent for a period of time sufficient to form a precipitate, and subsequently recovering the precipitate, the precipitating agent being present in an amount sufficient to precipitate all of the main proteins including non denatured enzymes from the liquid milk product.

In a further aspect of the present invention, there is provided a novel powdered milk product comprising milk proteins separated from a liquid milk product, the powdered milk product being characterized by containing substantially all of the proteins originally present in the liquid milk product including non denatured enzymes.

In the present invention, the use of the term “milk” refers to that liquid secreted by the mammary glands of female mammals and conventionally used for the nourishment of the young, including milk byproducts and/or derivatives wherein milk proteins are present. Thus, the milk could be whole milk, skim milk, a derivative thereof such as whey, etc. While milk normally refers to cows milk, the invention is also applicable to milk of other animals such as goats, llamas, reindeer, buffalo, sheep, camels, human, etc. It will be further understood that the present invention utilizes raw milk which has not been subject to any process such as pasteurization or the like which would denature the milk prior to treating the same according to the present invention.

In the present invention, the proteins which are recovered are substantially all those which were present in the original liquid milk product. In this respect, the main proteins of the milk product may be defined as all the different types of caseins which are considered major components and minor components and which can be quantified on densitograms of electrophoretic gels after staining with Coomassie Blue and represent more than 1% of the total scan of the milk product. Any differences between the recovery of the proteins and enzymes is within the normal variation present within a milk and within the scope of the variation due to testing equipment and procedures.

The method of the present invention comprises mixing with the milk a precipitation agent. Preferably, the precipitation agent is selected from the group consisting of acetone and ethanol.

The milk is preferably kept at a low temperature to reduce denaturation and the precipitation agent is slowly mixed therewith. Preferably, the precipitation agent is maintained and added at a relatively low temperature of between −20° C. and 4° C.

The amount of precipitation agent added to the milk may vary. It has been found that a preferred ratio of between 1:2 and 1:9 of milk to the precipitation agent on a volume/volume basis may be utilized when acetone is used. In general, it has been found that changing the ratio above 1:4 does not modify significantly the amount of protein recovered. However, the use of higher ratios does result in an increase in precipitate which is at least partially attributable to the coprecipitation of lactose which is not highly soluble in acetone.

As aforementioned, the process is preferably carried out at lower temperatures since it preserves enzyme integrity, although it will be understood that the process could be carried out at higher temperatures with certain disadvantages thereto. The lower temperatures also have the advantage of preventing or at least reducing the possibility of bacterial contamination.

The mixture of the milk and precipitation agent is preferably agitated for a period of time sufficient to permit the precipitation of the proteins. Generally, a time period of between 30 minutes and 60 minutes will result to a complete precipitation. Following the precipitation of the proteins, they may be removed by any conventional method such as filtration, use of a centrifuge, combinations thereof, etc.

Following removal of the precipitate when the precipitation agent is acetone, the precipitate is preferably washed with a water/acetone mixture to remove lactose. The water/acetone ratio may vary with a preferred ratio (volume/volume) being between 1:1 and 1:3. The precipitate may then be washed with pure acetone and the filter cake may then be dried by any suitable means, many such means being known in the art. Any traces of organic solvents can be eliminated by ventilating with a flow of air or inert gas through the precipitate.

When the precipitating agent is ethanol, the volume/volume ratio of milk/ethanol may vary between 1:1 and 1:5 with a preferred range being about 1:3. Following precipitation, the precipitate may be washed using pure ethanol.

In the process, it will be understood that the precipitating agent may be subsequently recovered by conventional methods and re-utilized.

### BRIEF DESCRIPTION OF THE DRAWINGS

Having thus generally described the invention, reference will be made to the following examples and figures, in which:

FIG. 1 is a schematic of a process for the separation of protein concentrates from skim milk and whey using acetone;

FIG. 2 is a schematic of a process used for the separation of protein concentrates from skim milk and whey using ethanol;

FIG. 3 is a schematic illustrating the process for the lipid extraction of filtrates obtained by protein concentrate isolation from whey using acetone;

FIG. 4 is a schematic illustrating the process for the lipid extraction of filtrates obtained by protein concentrate isolation from whey using ethanol;

FIG. 5 shows the proteins separated by SDS-polyacrylamide gel electrophoresis in Example 10;

FIG. 6 shows the proteins separated by SDS-polyacrylamide gel electrophoresis in Example 11;

FIG. 7 shows the sugars separated by thin-layer chromatography in Example 12;

FIG. 8 shows the sugars separated by thin-layer chromatography in Example 13;

FIG. 9 shows the sugars separated by thin-layer chromatography in Example 14;

FIG. 10 shows the sugars separated by thin-layer chromatography in Example 15;

FIG. 11 is a densitometry of the protein bands from lactoserum powder compared to total proteins of lactoserum; and

FIG. 12 is a densitometry of the proteins bands from skim milk powder compared to total proteins of skim milk

### DESCRIPTION OF THE PREFERRED EMBODIMENTS

The following examples are illustrative of certain embodiments of the invention, but are not limiting thereof.

### EXAMPLE 1

As a preliminary test, 1 volume of skim milk was slowly mixed to 4 volumes of acetone and the mixture swirled about 30 minutes at a temperature of about 4° C. The mixture was then filtered under reduced pressure and in an inert gas atmosphere. The precipitate was then washed with a volume of pure acetone and this was followed by a second filtration under reduced pressure and in an inert gas atmosphere. The precipitate was then recovered and protein content was determined by the Biuret method (Plummer, D. T. 1987. An introduction to practical biochemistry. 3th ed. McGraw-Hill Book Company, London). The same procedure was applied to a mixture of 1 volume of skim milk and 9 volumes of acetone. The results are set forth in Table 1.

TABLE 1
Protein content of protein concentrates
of cow milk treated with acetone

| | | | Milk Concentrates | |
|---|---|---|---|---|
| | | | Skim Milk to Acetone Proportion | |
| | | | (Volume) | |
| Exp. No. | Whole Milk | Yield (%) | 1:4 | 1:9 |
| 1- | 2.9-3.1* | | 3.1 | 3.1 |
| 2- | | | 2.8 | 2.7 |

*From the literature Determinations were made in triplicate on freshly collected milk from a pool of about 50 Holstein cows (bulk tank) from Agriculture Research Station of Canada at Lennoxville, Quebec. Numbers refer to the percentage calculated from the original volume of milk.

### EXAMPLE 2

The process as set forth in Example 1 was followed using 10 mL of skim milk with varying milk to acetone ratios. The results are set forth in Table 2.

TABLE 2
Amount of precipitate obtained with different
ratios of cow skim milk-acetone

| | Dry Weight of Precipitate |
|---|---|
| Skim Milk to Acetone Proportion (Volume) | (g) |
| 1:4 | 0.72 |
| 1:6 | 0.74 |
| 1:7 | 0.79 |
| 1:8 | 0.89 |
| 1:9 | 0.82 |

### EXAMPLE 3

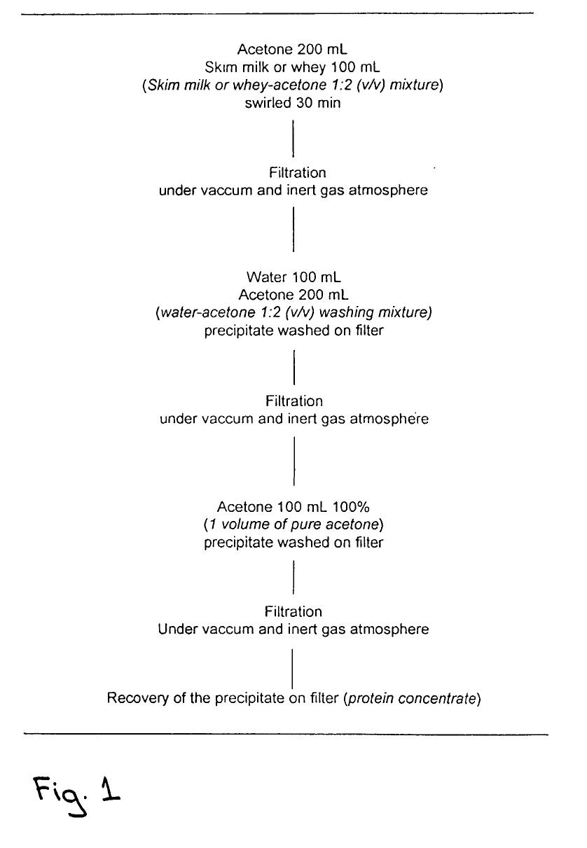

To determine the amount of lactose precipitate obtained with different proportions of acetone, 4 mL solutions of 5% lactose were exposed to variable proportions of acetone at 4° C. for 30 minutes. The precipitate that formed was centrifuged and acetone was evaporated with a stream of N₂. The results are set forth in Table 3 where it will be seen that an increasing proportion of acetone resulted in an increase in the amount of lactose precipitate. Using the procedure shown in FIG. 1 wherein a ratio of 1:2 (sample-acetone, v/v) and a washing of 1:2 water-acetone (v/v) follows, one obtains a precipitate poor in lactose.

TABLE 3
Amount of lactose precipitate obtained
with different proportions of acetone

| Lactose:Acetone Proportion (Volume) | Dry Weight of Precipitate (g) |
|---|---|
| 1:2 | 0.10 |
| 1:4 | 0.16 |
| 1:7 | 0.18 |
| 1:9 | 0.18 |

The weight corresponds to 4 mL of a 5% lactose solution.

### EXAMPLE 4

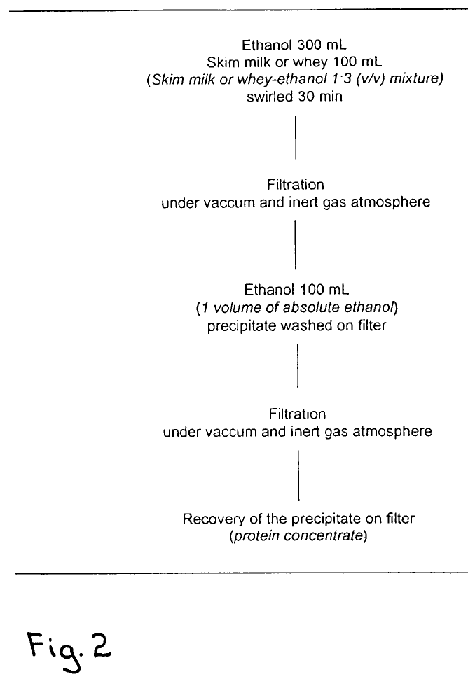

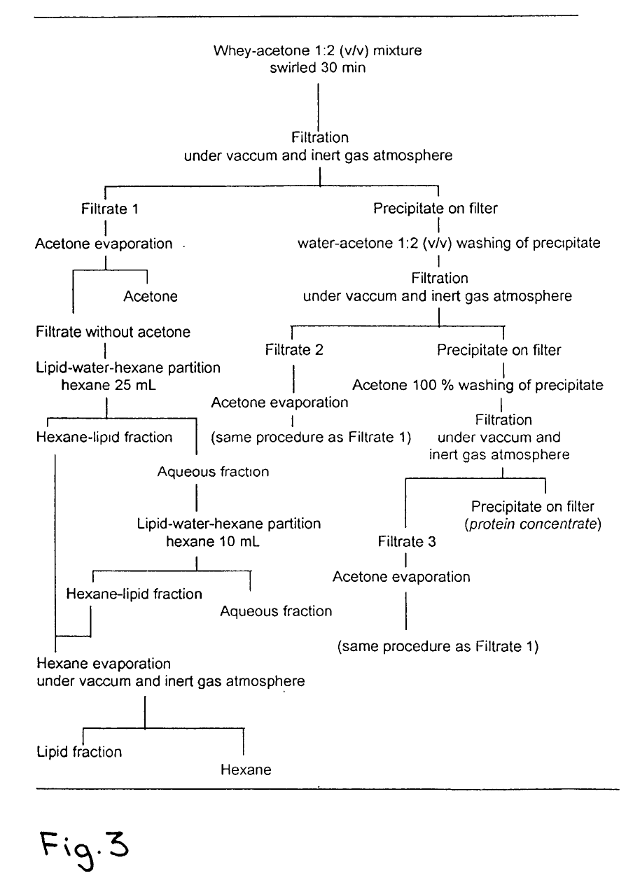

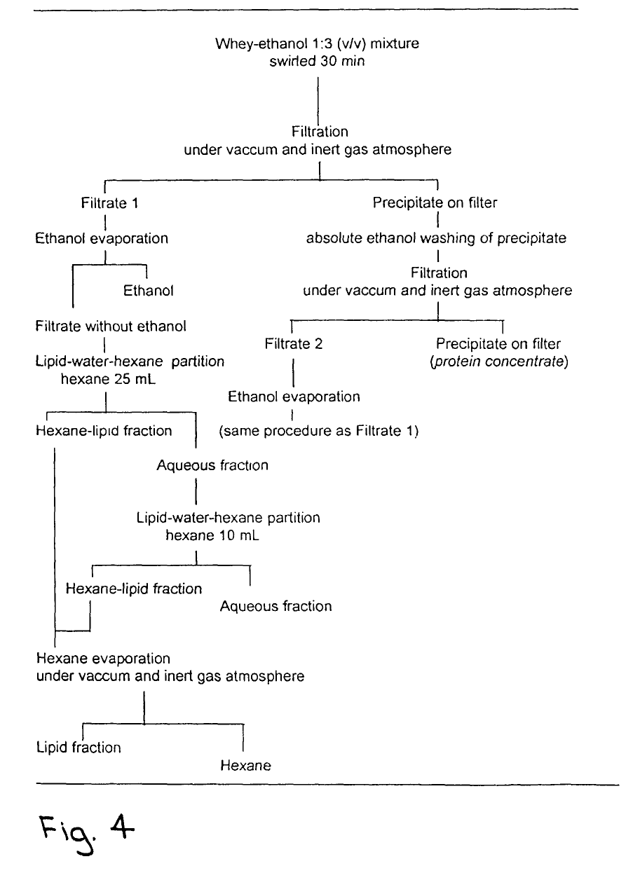

In this example, the capabilities of acetone and ethanol to precipitate proteins in skim milk were compared. The process using a ratio of 1:2 with acetone is shown in FIG. 1 and the process using ethanol is shown in FIG. 2 (ratio of 1:3). The results are set forth in Table 4.

TABLE 4
Amount of precipitate obtained with acetone
or ethanol from 100 mL of skim milk

| Source | Solvent | Dry Weight of Precipitate (g) |
|---|---|---|
| Skim milk | acetone | 1.98 |
| Skim milk | ethanol | 1.57 |

Determinations were made after drying at 80° C. for about 2 hours.

### EXAMPLE 5

In a manner similar to Example 4, the capabilities of acetone and ethanol to precipitate proteins in whey were compared. The 100 mL samples of whey, previously concentrated by ultra-filtration, were treated with acetone (1:2) and ethanol (1:3) as set out in Example 4. The results are set forth in Table 5.

TABLE 5
Amount of precipitate obtained with
acetone or ethanol from whey

| Source | Solvent | Dry Weight of Precipitate (g) |
|---|---|---|
| Whey | acetone | 12.31 |
| Whey | ethanol | 21.70 |

Determinations were made after drying at 80° C. for about 2 hours.

### EXAMPLE 6

This example shows the preservation of enzyme activity in the precipitate. Two enzymes known to be relatively unstable were assessed. There was a determination of alkaline phosphatase activity and alpha-amylase activity in the protein concentrate made with acetone.

Alkaline phosphatase activity. The enzyme assay was carried out at 20° C. with the following incubation medium: 6.9 mM MgCl₂, 5 mM paranitrophenyl phosphate in 0.11M glycine buffer, pH 8.8 (Garen, A. and Levinthal, C. 1960. A Fine-Structure Genetic and Chemical Study of the Enzyme Alkaline Phosphatase of E. coli. I. Purification and Characterization of Alkaline Phosphatase. Biochim. Biophys. Acta. 38(470)). Paranitrophenol is used as a standard of reference. Molar extinction coefficient at 425 nm us used to quantify the reaction product.

Alpha amylase activity. The enzyme assay was carried out according to Bernfeld (Bernfeld, P. 1951. Enzymes of Starch Degradation and Synthesis. Advances in Enzymol. 12(379)). Reducing groups liberated from starch have been measured by reduction of 3,5-dinitro salicylic acid. Maltose was used as a standard of reference to convert spectrophotometer readings to units of activity.

TABLE 6
Determination of alkaline phosphatase
and alpha-amylase activities in protein
concentrates made with acetone from skim milk

| Enzyme | Activity |
|---|---|
| Alkaline phosphatase | 0.85 nmole/min/mg |
| Alpha-amylase | 17.00 μmole/min/mg |

Determinations made in triplicate.

### EXAMPLE 7

Lipid concentration was determined in filtrates obtained during the preparation of a protein concentrate. The results are set forth in Table 7 wherein it may be seen that ethanol extracts more lipid than acetone.

TABLE 7
Lipid concentration in filtrates obtained
during protein concentrate isolation
from whey with acetone or ethanol

| Solvent | Filtrate No. | | Yield (%) |
|---|---|---|---|
| Acetone | 1 | | 0.12 |
| Acetone | 2 | | 0.00 |
| Acetone | 3 | | 0.00 |
| | | Total: | 0.12 |
| Ethanol | 1 | | 0.39 |
| Ethanol | 2 | | 0.10 |
| | | Total: | 0.49 |

The weight corresponds to 100 mL of whey. Determination made in triplicates.

### EXAMPLE 8

Concentrates obtained at various ratios of milk-acetone and made by the procedure described in Example 1 were analyzed and the results are shown in Table 8. It will be noted that the higher ratio of acetone produced a precipitate which was substantially enriched with lactose.

TABLE 8
Components concentrations in cow skim milk and
whey protein concentrates made with acetone

| | | | Moisture | | | |
|---|---|---|---|---|---|---|
| Source of | | Fat | level | Protein | Ashes | |
| protein | Ratio* | concentration | concentration | concentration | concentration | Lactose |
| concentrate | (v/v) | (%) | (%) | (%) | (%) | (%) |
| Cow skim milk | 1:4 | nd | nd | 42.83 | 6.90 | 39.50 |
| Cow skim milk | 1:9 | nd | nd | 34.04 | 5.71 | 48.60 |
| Cow skim milk | 1:4 | 0.47 | 15.97 | 44.78 | 7.75 | 29.65 |
| Cow whey | 1:2 | 2.74 | 10.59 | 70.57 | 4.13 | 8.79 |

*sample:acetone ratio (v/v).
nd: no data
Protein concentration determined by Kjeldahl method.

### EXAMPLE 9

Concentrates obtained from the procedure in FIG. 1 and FIG. 2 were analyzed and the results are shown in Table 9. It will be noted that drying the protein concentrate diminishes the humidity level in the concentrate. Acetone is a better precipitating agent than ethanol, but ethanol is more effective to get rid of fat in whey.

TABLE 9
Concentrations of three components in cow skim
milk and whey protein concentrates isolated
according to FIG. 1 (acetone) and FIG. 2 (ethanol)

| | | | | Proteins | |
|---|---|---|---|---|---|
| | Tech- | Humidity | Fat | Fresh Weight | Dry weight |
| Sample | nique | (%) | (%) | (%) | (%) |
| Skim milk^{a)} | acetone | 6.22 | 0.57 | 78.59 | 83.8 |
| Skim milk^{a)} | ethanol | 5.96 | 0.80 | 63.65 | 67.7 |
| Whey^{a)} | acetone | 10.11 | 1.62 | 80.82 | 89.9 |
| Whey^{a)} | ethanol | 45.99 | 0.83 | 39.87 | 73.8 |
| Skim milk | acetone | 63.50 | 0.42 | 29.95 | 82.0 |
| Skim milk | ethanol | 83.62 | 0.13 | 12.20 | 74.5 |

^{a)}Protein concentrate dried at 80° C. for about 2 hours.
Protein concentration determined by Kjeldahl method.

### EXAMPLE 10

Various proteins were analyzed by SDS-polyacrylamide gel electrophoresis, according to Laemmli (Laemmli, U. K. 1970. Cleavage of structural proteins during the assembly of the head of bacteriophage T4. Nature. 227(259): 680-685), and stained with coomassie blue. The following proteins were analyzed:

| | |
|---|---|
| A | molecular weight standard (26 μg) |
| B | whole milk (18 μg) |
| C | skim milk (24 μg) |
| D | pellet from filtrate of skim milk-acetone 1:4 (v/v) (<1 μg) |
| E | protein concentrate of skim milk-acetone 1:4 (v/v) (20 μg) |
| F | protein concentrate of skim milk-acetone 1:5 (v/v) (20 μg) |
| G | protein concentrate of skim milk-acetone 1:6 (v/v) (20 μg) |
| H | protein concentrate of skim milk-acetone 1:7 (v/v) (20 μg) |
| I | protein concentrate of skim milk-acetone 1:8 (v/v) (20 μg) |
| J | protein concentrate of skim milk-acetone 1:9 (v/v) (20 μg). |

### EXAMPLE 11

Various proteins were analyzed by SDS-polyacrylamide gel electrophoresis, according to Laemmli (1970), and stained with coomassie blue. The following proteins were analyzed:

| | |
|---|---|
| A | molecular weight standard (26 μg) |
| B | whole milk (18 μg) |
| C | skim milk (24 μg) |
| D | whey (18 μg) |
| E | protein concentrate of skim milk-acetone 1:2 (v/v) (27 μg) |
| F | protein concentrate of skim milk-ethanol 1:3 (v/v) (27 μg) |
| G | protein concentrate of whey-acetone 1:2 (v/v) (27 μg) |
| H | protein concentrate of whey-ethanol 1:3 (v/v) (27 μg) |
| I | protein concentrate of whey-acetone 1:2 (v/v) washed with |
| | ethanol (27 μg) |
| J | molecular weight standard (26 μg). |

### EXAMPLE 12

Various sugars were analyzed by thin-layer chromatography using ethyl acetate-isopropanol-water-pyridine (26:14:8:2 v/v) and were sprayed with 1% KMNO₄, 2% Na₂CO₃, according to Beaudoin (Beaudoin, A. 1999. Travaux pratiques de biochimie générale I BCM III. Université de Sherbrooke, Sherbrooke. 59). The following sugars were analyzed:

| | |
|---|---|
| Lane 1 | glucose (50 μg) |
| Lane 2 | protein concentrate of skim milk-acetone 1:7 (v/v) not warmed |
| Lane 3 | galactose (50 μg) |
| Lane 4 | filtrate pellet from protein concentrate of skim milk-acetone |
| | 1:4 (v/v) not warmed |
| Lane 5 | lactose (50 μg) |
| Lane 6 | protein concentrate of skim milk-acetone 1:4 (v/v) not warmed |
| Lane 7 | protein concentrate of skim milk-acetone 1:9 (v/v) not warmed. |

### EXAMPLE 13

Various sugars were analyzed by thin-layer chromatography using ethyl acetate-isopropanol-water-pyridine (26:14:8:2 v/v) and were sprayed with 1% KMNO₄, 2% Na₂CO₃, according to Beaudoin (1999). The following sugars were analyzed:

| | |
|---|---|
| Lane 1 | whey |
| Lane 2 | aqueous fraction of filtrate 1 from whey-acetone 1:2 (v/v) |
| Lane 3 | aqueous fraction of filtrate 2 from whey-acetone 1:2 (v/v) |
| Lane 4 | aqueous fraction of filtrate 3 from whey-acetone 1:2 (v/v) |
| Lane 5 | protein concentrate of whey-acetone 1:2 (v/v) warmed |
| Lane 6 | protein concentrate of skim milk-acetone 1:2 (v/v) warmed |
| Lane 7 | lactose (50 μg). |

### EXAMPLE 14

Various sugars were analyzed by thin-layer chromatography using ethyl acetate-isopropanol-water-pyridine (26:14:8:2 v/v) and were sprayed with 1% KMNO₄, 2% Na₂CO₃, according to Beaudoin (1999). The following sugars were analyzed:

| | |
|---|---|
| Lane 1 | whey |
| Lane 2 | skim milk |
| Lane 3 | aqueous fraction of filtrate 1 from whey-ethanol 1:3 (v/v) |
| Lane 4 | aqueous fraction of filtrate 2 from whey-ethanol 1:3 (v/v) |
| Lane 5 | protein concentrate of skim milk-ethanol 1:3 (v/v) warmed |
| Lane 6 | protein concentrate of whey-ethanol 1:3 (v/v) warmed |
| Lane 7 | lactose (50 μg). |

### EXAMPLE 15

Various sugars were analyzed by thin-layer chromatography using ethyl acetate-isopropanol-water-pyridine (26:14:8:2 v/v) and were sprayed with 1% KMNO₄, 2% Na₂CO₃, according to Beaudoin (1999). The following sugars were analyzed:

| | |
|---|---|
| Lane 1 | whey 1/100 |
| Lane 2 | milk 1/10 |
| Lane 3 | skim milk 1/10 |
| Lane 4 | protein concentrate of whey-acetone 1:2 (v/v) washed with |
| | ethanol and not warmed |
| Lane 5 | protein concentrate of whey-acetone 1:2 (v/v) washed with |
| | ethanol and warmed |
| Lane 6 | protein concentrate of skim milk-acetone 1:2 (v/v) not warmed |
| Lane 7 | lactose (50 μg). |

As shown in Table 1, the treatment of the skim milk results in a precipitate containing protein, and the amount of which is in accordance with the percentage of protein present in whole milk according to the literature. The increase in the ratio of acetone from 1:4 to 1:9 did not result in any increase in the amount of protein.

As shown in Example 2, wherein varying ratios of milk-acetone were tried, there was an increase in the total amount of the precipitate. Thus, there was obtained a precipitate ranging from between 7.2% to 8.9% compared to the known 3% in protein in milk. As shown in Table 8, the amount of protein recovered is consistent with the literature. However, the total amount of lactose recovered with the higher proportion of acetone would appear to be consistent with a decreased solubility of lactose in acetone.

Example 3 verifies the above wherein the proportion of lactose precipitate varies with the increase in acetone.

Example 4 indicates that acetone is a more effective precipitation agent for skim milk. However, ethanol is more effective for whey concentrated by ultra-filtration, compared to acetone, as shown in Table 5.

As shown in Example 6, enzyme activity is preserved in the protein precipitate compared to previously known means of obtaining the protein wherein the enzyme activity is lost.

The protein concentrates obtained with differing proportions of acetone were analyzed by SDS-polyacrylamide gel electrophoresis as set out in Example 10. The results are given in FIG. 5. As may be seen, there was no significant change of protein composition in any of the concentrates when compared to skim milk. In the case of the supernatant of the 1:4 sample precipitate, further addition of five volumes of acetone causes the formation of a small precipitate. The composition of this precipitate is shown in FIG. 5. It is noteworthy that one protein band (≈14.5 kDa) of whole milk (lane B) is absent from skim milk and protein concentrates compared with whole milk.

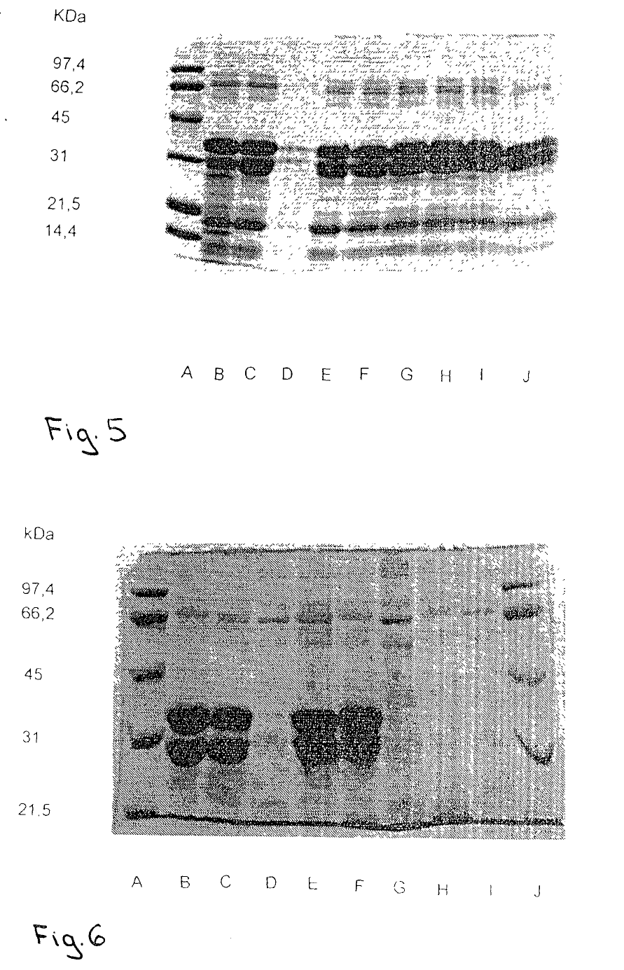

FIG. 6 shows the proteins separated by SDS-polyacrylamide gel electrophoresis of Example 11 and it may be seen that there are marked differences between the protein profile of milk and whey. Thus, the milk proteins around 31 kDa are present in lower concentration in whey, as expected, since these proteins are partially used in the cheese production process. It will also be seen that a protein around 66 kDa is absent from whey (the protein in the doublet with the lowest molecular weight). FIG. 6 also shows that the ethanol precipitates the same proteins as acetone, in about the same concentrations, except for a protein around 21.5 kDa present in concentrate from whey and skim milk prepared with acetone, but absent from ethanol concentrates.

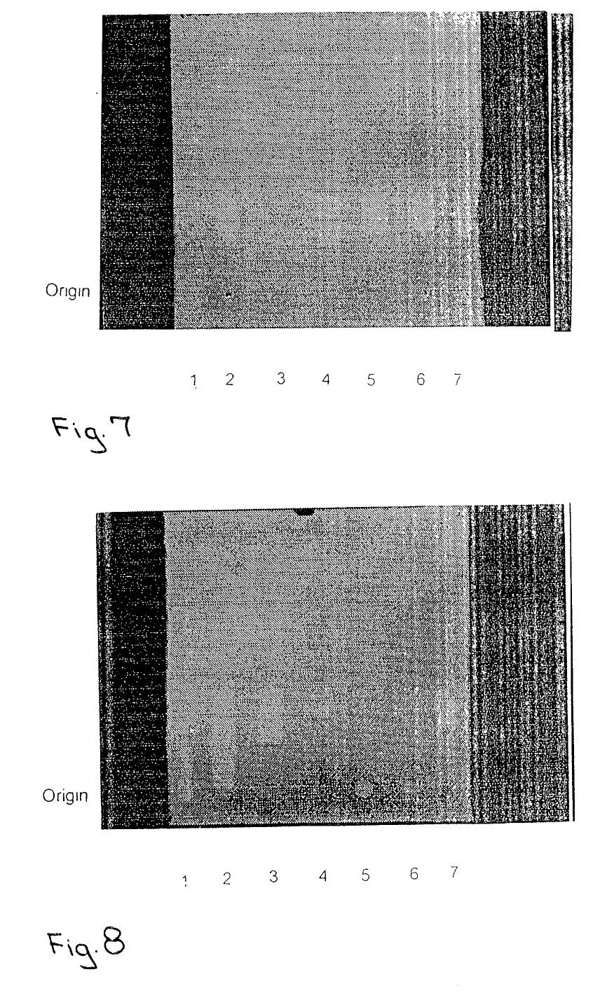

FIG. 7 shows the sugars present in protein concentrates separated by thin-layer chromatography (see Example 12). It may be seen that the amount of lactose in the protein concentrate increases with increasing acetone ratios. As seen in lane 4, treatment of the supernatant from the 1:4 sample (with an additional five volumes of acetone) causes the formation of a lactose precipitate with practically no protein (Example 10 and FIG. 5). Comparison of the precipitates further confirms the enrichment in lactose of the protein concentrate at higher proportions of acetone. In FIGS. 7 to 10, the lactose standard is loaded at a concentration of 10 mg/mL, that corresponds to a 1% lactose solution. FIG. 8 shows that there is practically no detectable lactose in protein concentrate prepared with a low proportion of acetone (sample-acetone ratio 1:2 (v/v)). Lactose is found in the filtrate and more specifically in the aqueous fraction (lane 2, 3 and 4). This confirms that lactose is soluble in acetone when the latter solvent is used at a relatively low ratio (1:2 (v/v)). Washing of the precipitate on the filter with a solution containing water is needed to get rid of lactose in the protein concentrate as shown by the thin-layer chromatography of the filtrates.

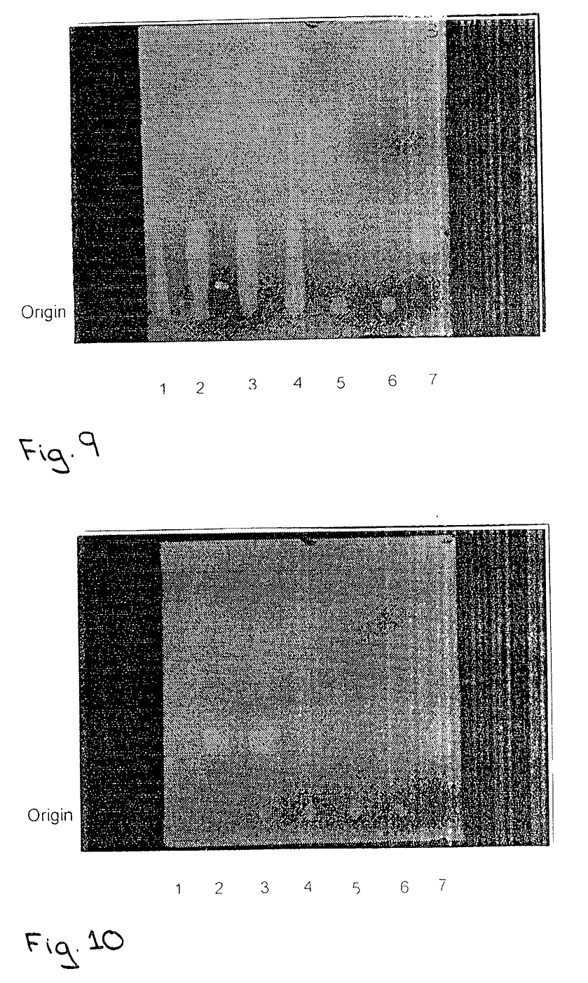

FIG. 9 indicates that a skim milk protein concentrate made with ethanol contains lactose in contrast to the acetone extract which is devoid of this sugar (see FIG. 8, lane 6). Whey protein concentrates made from ethanol does not contain detectable lactose as for protein concentrate made with acetone (see FIG. 8, lane 5), probably because lactose is consumed during fermentation.

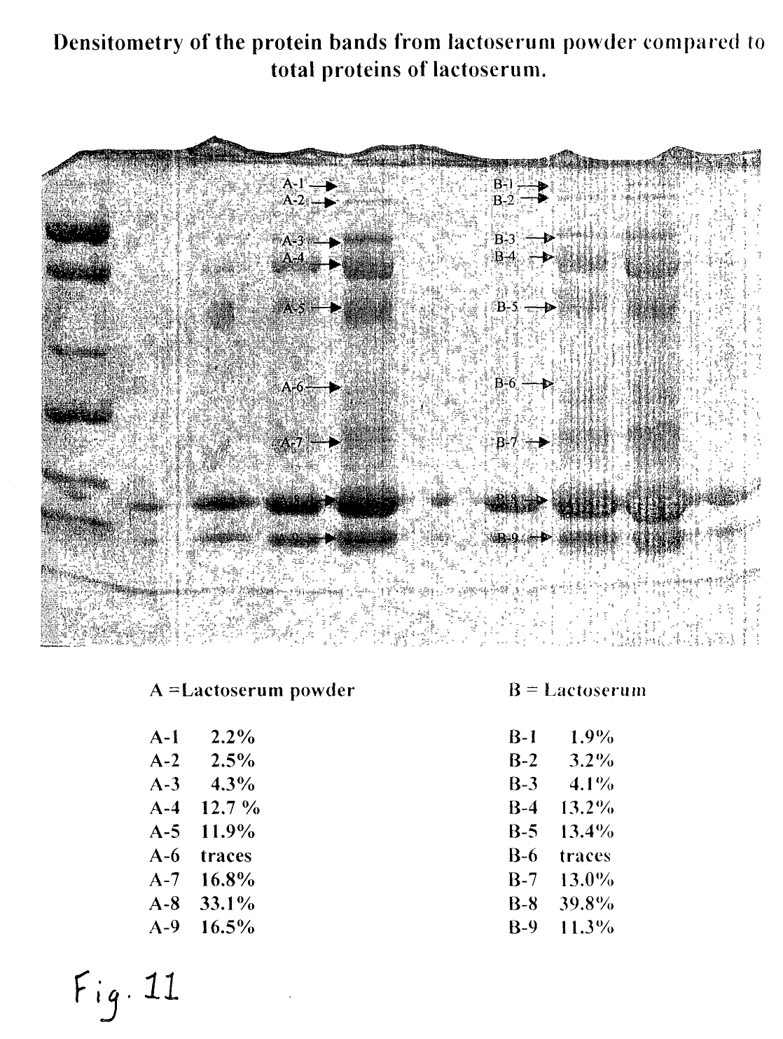

As shown in FIG. 10, a whey protein concentrate made from acetone and washed with ethanol lacks significant amount of the lactose. The same results were obtained from heated and unheated samples of the concentrate. In lane 6 of FIG. 10, there is no observable lactose (skim milk protein concentrate not heated) as in lane 6 of FIG. 8 (skim milk protein concentrate heated). In FIG. 10, lane 1 indicated nothing observable as the sample was too diluted (1/100).

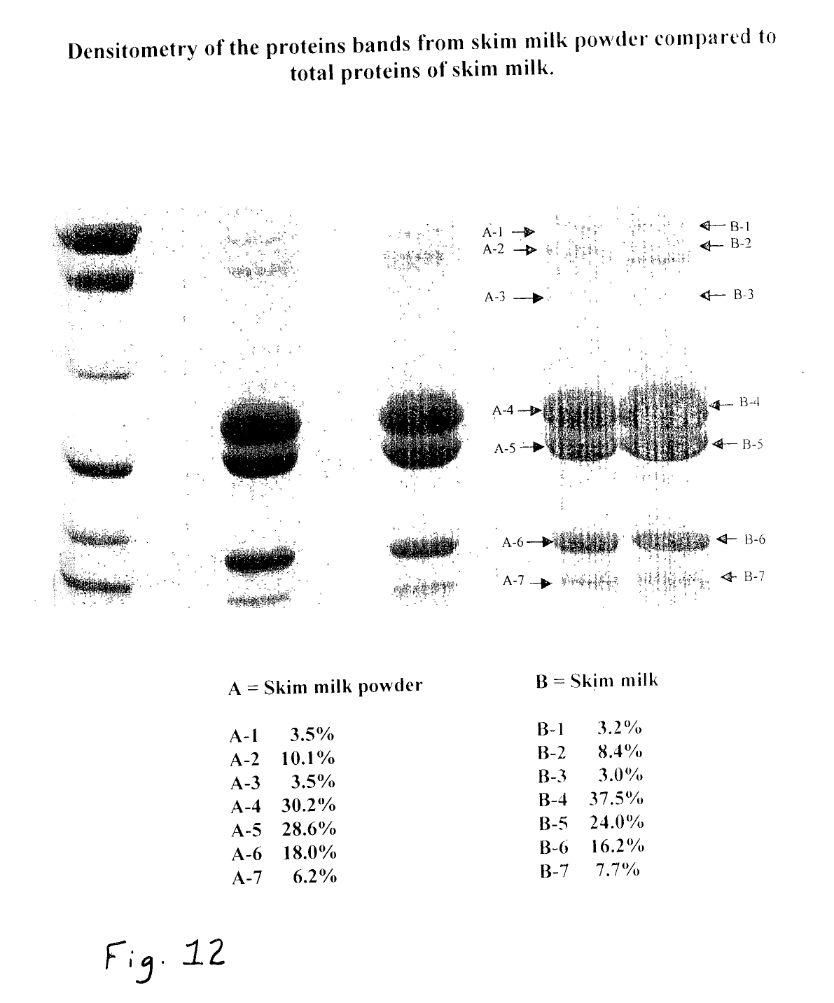

As will be seen from the densitometries illustrated in FIGS. 11 and 12, there is seen that there is a quantitative recovery of the proteins.

It will be understood that the above examples are given by way of illustration only and that they are not intended to be limiting of the invention. It is further evident that changes and modifications may be made to the above described embodiments without departing from the spirit and scope of the invention.

I claim:

1. A method for the recovery of all of the main proteins and enzymes from a liquid milk product, said method comprising the steps of supplying a raw unpasteurized liquid milk product, adding a precipitating agent selected from the group consisting of ethanol and acetone to said raw unpasteurized liquid milk product, mixing said raw unpasteurized milk product and said precipitating agent for a period of time sufficient to form a precipitate, and subsequently recovering said precipitate, said precipitating agent being present in an amount sufficient to precipitate all of said main proteins including non denatured enzymes from said liquid milk product.

2. The method of claim 1 wherein said precipitating agent is ethanol.

3. The method of claim 1 wherein said precipitating agent is acetone.

4. The method of claim 1 wherein said liquid milk product is selected from the group consisting of whole milk, skim milk, whey, and a fraction of milk obtained by acid, alkaline precipitation or by ultra-filtration.

5. The method of claim 3 wherein the step of mixing said liquid milk product with said acetone comprises the step of mixing said acetone with said liquid milk product in an acetone/milk volume ratio of between 2:1 and 9:1.

6. The method of claim 2 wherein said step of mixing said liquid milk product with said ethanol comprises the step of mixing said ethanol with said liquid milk product in an ethanol/milk volume ratio of between 2:1 and 5:1.

7. The method of claim 1 wherein said step of mixing said liquid milk product with said precipitating agent is carried out at a temperature of below about 4° C.

8. The method of claim 1 wherein said step of recovering said precipitate comprises the step of recovering said precipitate through filtration.

9. The method of claim 1 wherein said step of recovering said precipitate comprises the step of recovering said precipitate through centrifuging.

10. The method of claim 8 further including the steps of washing said precipitate with water and with acetone.

11. The method of claim 1 wherein the step of mixing said liquid milk product with a precipitating agent comprises the step of mixing said liquid milk product with said precipitating agent to form a mixture and agitating said mixture.

12. The method of claim 4 further including the step of treating said precipitate with acetone to selectively dissolve lactose in said precipitate and remove said lactose.

13. The method of claim 4 further including the step of recovering lipids from said liquid milk product.

14. A powdered milk product comprising milk proteins separated from a liquid milk product, said powdered milk product being characterized by containing substantially all of the proteins originally present in said liquid milk product including active enzymes.
